(19) United States
(12) Patent Application Publication
(10) Pub. No.: US 2024/0345315 A1
(43) Pub. Date: Oct. 17, 2024

(54) OPTOELECTRONIC PACKAGE

(71) Applicant: Advanced Semiconductor Engineering, Inc., Kaohsiung (TW)

(72) Inventors: Chun-Yen TING, Kaohsiung (TW); Hung-Chun KUO, Kaohsiung (TW); Jung Jui KANG, Kaohsiung (TW); Chiu-Wen LEE, Kaohsiung (TW); Shih-Yuan SUN, Kaohsiung (TW)

(73) Assignee: Advanced Semiconductor Engineering, Inc., Kaohsiung (TW)

(21) Appl. No.: 18/135,075

(22) Filed: Apr. 14, 2023

(51) Int. Cl. G02B 6/122; G02B 6/12

(52) U.S. Cl. CPC G02B 6/1225; G02B 6/12002; G02B 2006/12147

(57) ABSTRACT

An optoelectronic package is provided. The optoelectronic package includes a photonic structure, an alignment component and a light transmission element. The photonic structure includes an optical I/O. The alignment component includes a through hole extending through the alignment component and aligned with the optical I/O of the photonic structure. The light transmission element entirely fills the through hole of the alignment component.

### BACKGROUND

### 1.Field of the Disclosure

The present disclosure relates to an optoelectronic package, and to an optoelectronic package including an alignment component.

### 2. Description of the Related Art

Silicon photonics has the advantages of high transmission rate and low power consumption, and its application prospects in optical communication are promising, such as servers, laser radars (Lidar), etc. Coupling optical fibers and optical communication chips in optical transceiver terminals usually need accurate alignment. However, alignment processes between the optical fibers and the optical communication chips are difficult to handle, resulting in increased loss of optical signals. With the increasing demand for bandwidth and miniaturization, the alignment between the optical fiber and the optical communication chip becomes more critical.

### SUMMARY

In some embodiments, an optoelectronic package includes a photonic structure, an alignment component and a light transmission element. The photonic structure includes an optical I/O. The alignment component includes a through hole extending through the alignment component and aligned with the optical I/O of the photonic structure. The light transmission element entirely fills the through hole of the alignment component.

In some embodiments, an optoelectronic package includes a photonic structure and an alignment component. The photonic structure includes an optical I/O. The alignment component includes a light transmission channel aligned with the optical I/O of the photonic structure through a plurality of alignment pads.

In some embodiments, an optoelectronic package includes a photonic structure and an alignment component. The photonic structure includes an optical I/O. The alignment component includes a light transmission channel configured to self-align with the optical I/O of the photonic structure during a reflow process.

### BRIEF DESCRIPTION OF THE DRAWINGS

Aspects of some embodiments of the present disclosure are readily understood from the following detailed description when read with the accompanying figures. It is noted that various structures may not be drawn to scale, and dimensions of the various structures may be arbitrarily increased or reduced for clarity of discussion.

FIG. 1 illustrates a cross-sectional view of an optoelectronic package according to some embodiments of the present disclosure.

FIG. 2 illustrates an enlarged view of an area “A” of FIG. 1.

FIG. 3 illustrates a bottom view of an alignment component according to some embodiments of the present disclosure.

FIG. 4 illustrates a cross-sectional view of an optoelectronic package according to some embodiments of the present disclosure.

FIG. 5 illustrates a cross-sectional view of an optoelectronic package according to some embodiments of the present disclosure.

FIG. 6 illustrates a cross-sectional view of an optoelectronic package according to some embodiments of the present disclosure.

FIG. 7 illustrates a cross-sectional view of an alignment component according to some embodiments of the present disclosure.

FIG. 8 illustrates one or more stages of an example of a method for manufacturing an optoelectronic package according to some embodiments of the present disclosure.

FIG. 9 illustrates one or more stages of an example of a method for manufacturing an optoelectronic package according to some embodiments of the present disclosure.

FIG. 10 illustrates one or more stages of an example of a method for manufacturing an optoelectronic package according to some embodiments of the present disclosure.

### DETAILED DESCRIPTION

Common reference numerals are used throughout the drawings and the detailed description to indicate the same or similar components. Embodiments of the present disclosure will be readily understood from the following detailed description taken in conjunction with the accompanying drawings.

The following disclosure provides many different embodiments, or examples, for implementing different features of the provided subject matter. Specific examples of components and arrangements are described below to explain certain aspects of the present disclosure. These are, of course, merely examples and are not intended to be limiting. For example, the formation of a first feature over or on a second feature in the description that follows may include embodiments in which the first and second features are formed or disposed in direct contact, and may also include embodiments in which additional features may be formed or disposed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

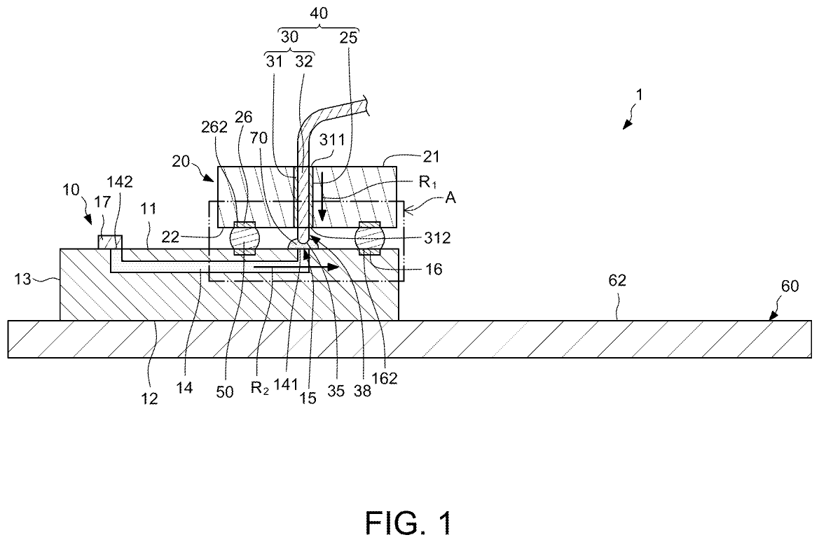

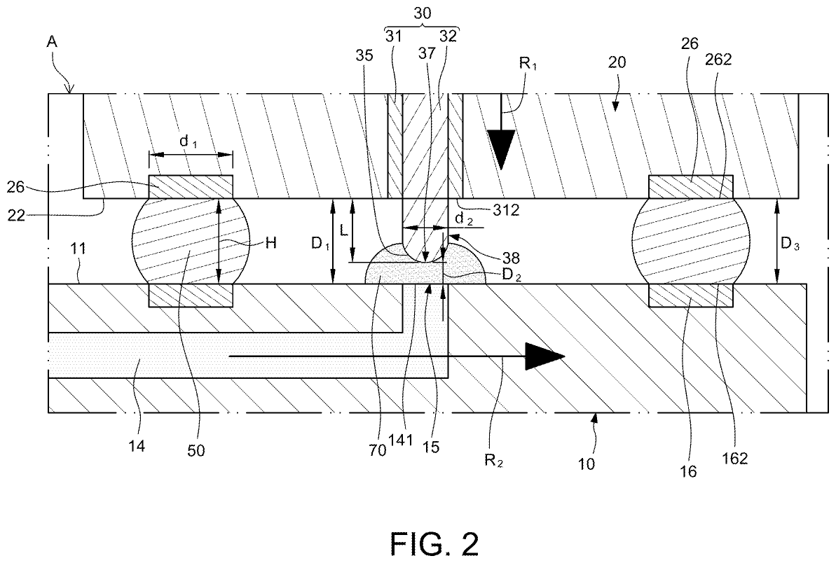

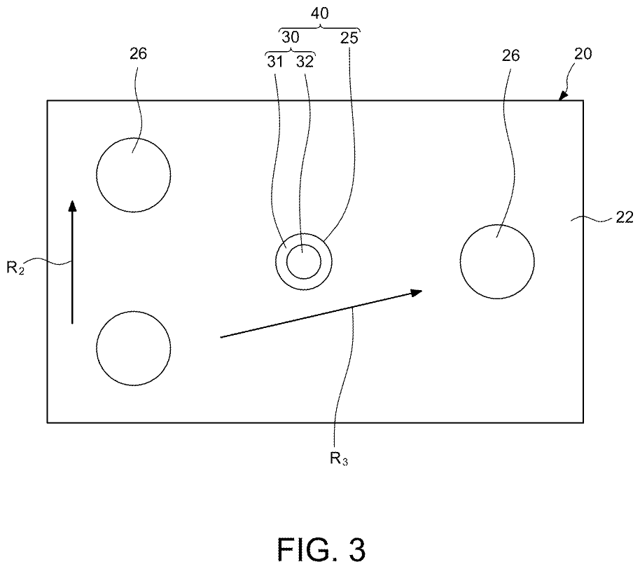

FIG. 1 illustrates a cross-sectional view of an optoelectronic package 1 according to some embodiments of the present disclosure. FIG. 2 illustrates an enlarged view of an area “A” of FIG. 1. FIG. 3 illustrates a bottom view of an alignment component 20 according to some embodiments of the present disclosure. The optoelectronic package 1 includes a photonic structure 10, an alignment component 20, a light transmission element 30, a plurality of connectors 50, a coupling material 70 and a carrier 60. In some embodiments, the optoelectronic package 1 may be, for example, an optical communication device.

The photonic structure 10 may be, for example, a silicon photonic structure. The photonic structure 10 may have an upper surface 11, a lower surface 12 opposite to the upper surface 11 and a lateral surface 13 extending between the upper surface 11 and the lower surface 12. The photonic structure 10 may include a waveguide 14, an optical I/O 15, a plurality of bonding pads 16 and an optoelectronic component 17. The waveguide 14 may be configured to transmit an optical signal. In some embodiments, as sown in FIG. 1, the waveguide 14 may have a first port 141 and a second port 142 opposite to the first port 141. The first port 141 and the second port 142 may be exposed from the upper surface 11 and configured to couple the optical signal. The waveguide 14 may be embedded in the photonic structure 10, and may be disposed adjacent to the upper surface 11.

The optical I/O 15 may be disposed at the first port 141 of the waveguide 14 and configured to input or output the optical signal. In some embodiments, the optical I/O 15 may also be referred to as “input/output (I/O) port” or “optical receive region.” In some embodiments, the optical I/O 15 may be the first port 141 of the waveguide 14. In some embodiments, the optical I/O 15 may be, for example, a flat surface or a curved surface.

The plurality of bonding pads 16 may be disposed adjacent to the upper surface 11 of the photonic structure 10. In some embodiments, as shown in FIG. 2, the plurality of bonding pads 16 may be exposed from the upper surface 11 of the photonic structure 10. In some embodiments, top surfaces 162 of the plurality of bonding pads 16 may be substantially coplanar with the first port 141 of the waveguide 14 and the optical I/O 15. In some embodiments, the plurality of bonding pads 16 may surround or may be disposed around the optical I/O 15.

As shown in FIG. 1, the optoelectronic component 17 may be, for example, a laser diode (LD) or a photodetector (PD). In some embodiments, the optoelectronic component 17 may be coupled with the second port 142 of the waveguide 14. In some embodiments, the optoelectronic component 17 (e.g., the LD) may be configured to emit the optical signal into the waveguide 14 from the second port 142. In some embodiments, the optoelectronic component 17 (e.g., the PD) may be configured to receive the optical signal from the second port 142 of the waveguide 14.

The alignment component 20 may be, for example, a semiconductor die. The semiconductor die may be, for example, a function die with electrical function or a dummy die without electrical function. The alignment component 20 may be located over the photonic structure 10. In some embodiments, as shown in FIG. 1, the alignment component 20 may be electrically connected and physically connected to the photonic structure 10 through the plurality of connectors 50. In some embodiments, the plurality of connectors 50 may also be referred to as “reflowable elements.” In some embodiments, the plurality of connectors 50 may be, for example, solder balls or conductive pillars. In some embodiments, the plurality of connectors 50 may include a reflowable material. The alignment component 20 may have an upper surface 21, a lower surface 22 and a through hole 25. The lower surface 22 is opposite to the upper surface 21. The through hole 25 may extend through the alignment component 20 and in communication with the upper surface 21 and the lower surface 22. In some embodiments, as shown in FIG. 2, the alignment component 20 may include a plurality of alignment pads 26. The plurality of alignment pads 26 may be disposed adjacent to the lower surface 22 of the alignment component 20. In some embodiments, the plurality of alignment pads 26 may be located on and exposed from the lower surface 22 of the alignment component 20. In some embodiments, as shown in FIG. 2, the plurality of alignment pads 26 may be arranged in a second direction R₂. The second direction R₂ may be substantially parallel to the lower surface 22 of the alignment component 20. In some embodiments, as shown in FIG. 3, the plurality of alignment pads 26 may be further arranged in a third direction R₃ different from the second direction R₂. The third direction R₃ may not be perpendicular to the second direction R₂. Thus, the plurality of alignment pads 26 in the second direction R₂ and the plurality of alignment pads 26 in the third direction R₃ may define a position on a plane to facilitate alignment. In some embodiments, the plurality of connectors 50 may connect the plurality of alignment pads 26 of the alignment component 20 to the upper surface 11 of the photonic structure 10. In some embodiments, an amount of the plurality of alignment pads 26 may be greater than or equal to 3 to constitute an alignment plane, which may be equal to an amount of the plurality of bonding pads 16 of the photonic structure 10. A size of the alignment pad 26 the alignment component 20 may be substantially equal to a size of the bonding pad 16 of the photonic structure 10. A location of the alignment pad 26 the alignment component 20 may correspond to a location of the bonding pad 16 of the photonic structure 10. In some embodiments, the plurality of connectors 50 may connect the plurality of alignment pads 26 of the alignment component 20 and the plurality of bonding pads 16 of the photonic structure 10. In some embodiments, bottom surfaces 262 of the plurality of alignment pads 26 may be substantially coplanar with the lower surface 22 of the alignment component 20. In some embodiments, the through hole 25 may be aligned with the optical I/O 15 of the photonic structure 10 through the plurality of alignment pads 26 during a reflow process due to a cohesion force of a reflowable material of the plurality of connectors 50. In some embodiments, at least one of the plurality of alignment pads 26 may be electrically insulated. In some embodiments, from a cross-sectional view, a width of the through hole 25 may be greater than a width of the optical I/O 15 and a width of the first port 141 of the waveguide 14.

In some embodiments, as shown in FIG. 1, the light transmission element 30 may entirely or completely fill the through hole 25 of the alignment component 20. Thus, the light transmission element 30 and the through hole 25 of the alignment component 20 may constitute a light transmission channel 40. The alignment component 20 may fix the light transmission channel 40 and align the light transmission channel 40 with the optical I/O 15 of the photonic structure 10 in a first direction R₁. The first direction R₁ may be different from the second direction R₂ and the third direction R₃. In some embodiments, the first direction R₁ may be substantially perpendicular to the second direction R₂ and the third direction R₃. In some embodiments, the light transmission channel 40 (including, for example, the light transmission element 30 and the through hole 25 of the alignment component 20) may be configured to self-align with the optical I/O 15 of the photonic structure 10 through the plurality of alignment pads 26 on the alignment component 20 during the reflow process due to the cohesion force of the reflowable material of the plurality of connectors 50. In some embodiments, a heat resistance temperature of the light transmission element 30 of the light transmission channel 40 may be greater than a reflow temperature of the reflow process and a melting point of the plurality of connectors 50. Thus, the light transmission element 30 of the light transmission channel 40 remains solid state during the reflow process. In some embodiments, the plurality of alignment pads 26 may be around the light transmission channel 40.

In some embodiments, as shown in FIG. 1, the light transmission element 30 may include a filling material 31, an optical fiber 32 and a light communication port 35. The filling material 31 may be in the through hole 25 of the alignment component 20. The filling material 31 may be, for example, a transparent glue material. The filling material 31 may have a top surface 311 and a bottom surface 312 opposite to the top surface 311. In some embodiments, the top surface 311 of the filling material 31 may be substantially aligned with the upper surface 21 of the alignment component 20. The bottom surface 312 of the filling material 31 may be substantially aligned with the lower surface 22 of the alignment component 20. The optical fiber 32 may extend through the filling material 31 and aligned with the optical I/O 15 of the photonic structure 10. In some embodiments, the plane defined by the plurality of alignment pads 26 in the second direction R₂ and the plurality of alignment pads 26 in the third direction R₃ may improve the alignment of the optical fiber 32. In some embodiments, the optical fiber 32 may be fixed in the through hole 25 of the alignment component 20 through the filling material 31. Thus, the filling material 31 may be interposed between an outer surface of the optical fiber 32 and a sidewall of the through hole 25. In some embodiments, a refractive index of the filling material 31 may be less than a refractive index of a core material of the optical fiber 32 so as to keep a condition of total internal reflection. In some embodiments, the refractive index of the filling material 31 may be less than or equal to a refractive index of a cladding material of the optical fiber 32 so as to maintain the condition of total internal reflection. In some embodiments, a volume of the filling material 31 may be less than a volume of the optical fiber 32 in the through hole 25.

The light communication port 35 may be located outside the through hole 25 of the alignment component 20 and aligned with the optical I/O 15 of the photonic structure 10. In some embodiments, the light communication port 35 may be an end portion of the optical fiber 32 adjacent to the optical I/O 15 of the photonic structure 10. In some embodiments, the light communication port 35 may be, for example, a flat surface or a curved surface. In some embodiments, the light communication port 35 may be an optical surface from which light leaves or enters the light transmission element 30. In some embodiments, the optical surface may be an interface between different refractive indices. In some embodiments, the optical surface may be a boundary between two optical media with different refractive indices. In some embodiments, as shown in FIG. 2, a vertical distance D₂ between the light communication port 35 and the optical I/O 15 may be less than a vertical distance D₁ between the lower surface 22 of the alignment component 20 and the upper surface 11 of the photonic structure 10 and a vertical distance D₃ from the bottom surfaces 262 of the plurality of alignment pads 26 to the upper surface 11 of the photonic structure 10. In some embodiments, a lens structure 37 may be formed or disposed on the light communication port 35 to increase a light coupling efficiency between the light communication port 35 and the optical I/O 15. In some embodiments, the lens structure 37 may be a hemisphere. In some embodiments, a coupling manner between the light communication port 35 and the optical I/O 15 may be, for example, grating coupling (e.g., using a grating coupler) or direct coupling. In some embodiments, the grating coupler (not shown) may be formed or disposed on the light communication port 35. In some embodiments, the grating coupler (not shown) may be formed or disposed on the optical I/O 15.

In some embodiments, as shown in FIG. 2, the plurality of connectors 50 may be around the light communication port 35. In some embodiments, an elevation of the light communication port 35 may be lower than elevations of top surfaces of the plurality of connectors 50. In some embodiments, the elevation of the light communication port 35 may be between the elevations of top surfaces of the plurality of connectors 50 and elevations of bottom surfaces of the plurality of connectors 50. In some embodiments, the elevation of the light communication port 35 may be lower than elevations of the plurality of alignment pads 26. In some embodiments, the elevation of the light communication port 35 may be between the lower surface 22 of the alignment component 20 and the upper surface 11 of the photonic structure 10. In some embodiments, a diameter d₁ of one of the plurality of alignment pads 26 may be greater than a diameter d₂ of the light communication port 35. In some embodiments, the diameter d₁ of one of the plurality of alignment pads 26 may be less than the diameter d₂ of the light communication port 35.

In some embodiments, as shown in FIG. 2, the light transmission element 30 may further include an extending portion 38. The light communication port 35 may be one end of the extending portion 38. The extending portion 38 may protrude downward from the lower surface 22 of the alignment component 20. Thus, the light communication port 35 may extend beyond the lower surface 22 of the alignment component 20. The optical fiber 32 may extend through the alignment component 20. In some embodiments, a length L of the extending portion 38 may be less than heights H of the plurality of connectors 50. Thus, there may be a gap between the light communication port 35 and the optical I/O 15. The light communication port 35 may not contact the optical I/O 15.

The coupling material 70 may be, for example, an index matching material. The coupling material 70 may be a glue, and may be disposed between the light communication port 35 and the optical I/O 15 of the photonic structure 10 to adhere the light communication port 35 and the optical I/O 15. The coupling material 70 may increase the light coupling efficiency between the light communication port 35 and the optical I/O 15. In some embodiments, as shown in FIG. 2, the coupling material 70 may cover the light communication port 35 and the optical I/O 15 to isolate a portion of the light communication port 35 and the optical I/O 15 from the air. In some embodiments, the coupling material 70 may be omitted.

In some embodiments, as shown in FIG. 1, the carrier 60 may be configured to receive the photonic structure 10. In some embodiments, the photonic structure 10 may be disposed on a first surface (e.g., a top surface) 62 of the carrier 60. In some embodiments, the light transmission element 30 in the through hole 25 of the alignment component 20 may be substantially perpendicular to the first surface (e.g., the top surface) 62 of the carrier 60.

In the embodiment illustrated in FIG. 1 to FIG. 3, the light transmission channel 40 (including, for example, the light transmission element 30 and the through hole 25 of the alignment component 20) can be aligned with the optical I/O 15 of the photonic structure 10 through the plurality of alignment pads 26 during the reflow process, lead to increased light coupling efficiency between the light communication port 35 of the light transmission channel 40 and the optical I/O 15 of the photonic structure 10 and decreased loss of the optical signal. In the optoelectronic package 1, the electrical signal may be transmitted between the photonic structure 10 and the alignment component 20 through the connectors 50.

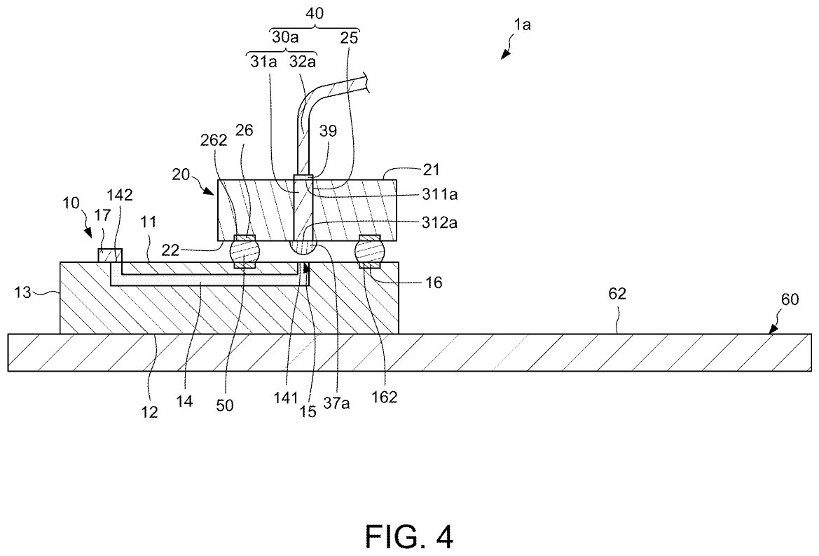

FIG. 4 illustrates a cross-sectional view of an optoelectronic package 1a according to some embodiments of the present disclosure. The optoelectronic package 1a of FIG. 4 is similar to the optoelectronic package 1 of FIG. 1, except for a structure of the light transmission element 30a. In some embodiments, as shown in FIG. 4, the light transmission element 30a may include an optical through silicon via (TSV) 31a and an optical fiber 32a. In some embodiments, the optical TSV 31a may be, for example, a silicon-base material. The optical TSV 31a may be formed or disposed in the through hole 25 of the alignment component 20. The optical TSV 31a may have a top surface 311a and a bottom surface 312a opposite to the top surface 311a. In some embodiments, the top surface 311a of the optical TSV 31a may be substantially coplanar with the upper surface 21 of the alignment component 20. The bottom surface 312a of the optical TSV 31a may be substantially coplanar with the lower surface 22 of the alignment component 20 and the bottom surfaces 262 of the plurality of alignment pads 26.

The optical fiber 32a may be coupled to the top surface 311a of the optical TSV 31a. In some embodiments, as shown in FIG. 4, an index matching material 39 may be disposed between the optical fiber 32a and the top surface 311a of the optical TSV 31a to increase a light coupling efficiency between the optical fiber 32a and the optical TSV 31a. In some embodiments, a lens structure 37a may be formed or disposed on the bottom surface 312a of the optical TSV 31a to increase a light coupling efficiency between the optical TSV 31a and the optical I/O 15 of the photonic structure 10. In some embodiments, the lens structure 37a and the optical TSV 31a may be formed concurrently. In some embodiments, a coupling manner between the optical TSV 31aand the optical I/O 15 may be, for example, grating coupling (e.g., using a grating coupler) or direct coupling. In some embodiments, the grating coupler (not shown) may be formed or disposed on the bottom surface 312a of the optical TSV 31a. In some embodiments, the grating coupler (not shown) may be formed or disposed on the optical I/O 15.

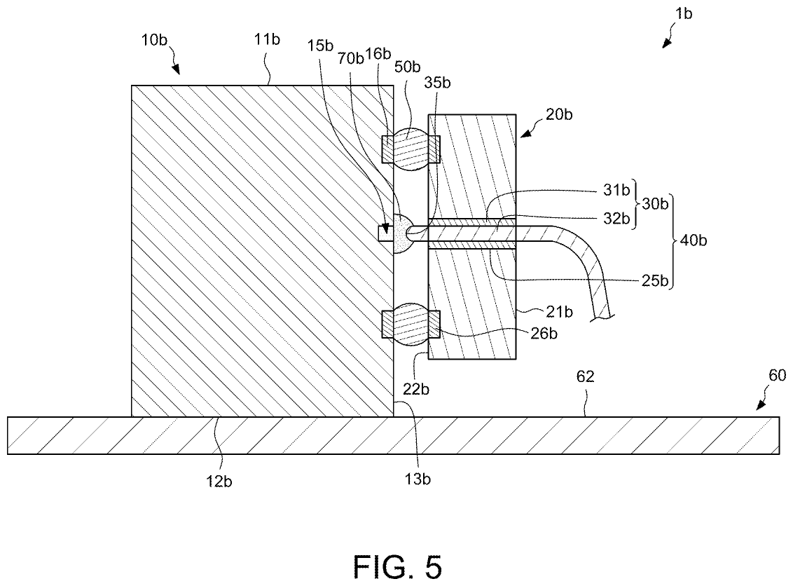

FIG. 5 illustrates a cross-sectional view of an optoelectronic package 1b according to some embodiments of the present disclosure. The optoelectronic package 1b of FIG. 5 is similar to the optoelectronic package 1 of FIG. 1, except for configurations of the photonic structure 10 b and the alignment component 20b. In some embodiments, as shown in FIG. 5, the optical I/O 15b and the plurality of bonding pads 16b of the photonic structure 10b may be exposed from the lateral surface (e.g., a second surface) 13b extending between the upper surface (e.g., a first surface) 11b and the lower surface (e.g., a third surface) 12b. The alignment component 20b of FIG. 5 may be a configuration after rotating the alignment component 20 of FIG. 1 by 90 degrees. That is, the bottom surface 22b and the plurality of alignment pads 26b of the alignment component 20b may face the lateral surface 13b of the photonic structure 10b. The first surface (e.g., the top surface) 62 of the carrier 60 may be substantially perpendicular to the lateral surface 13b of the photonic structure 10b. In addition, the light transmission channel 40b (including, for example, the through hole 25b of the alignment component 20b and the light transmission element 30b in the through hole 25b) of the alignment component 20b may be substantially parallel to the first surface (e.g., the top surface) 62 of the carrier 60. In some embodiments, as shown in FIG. 5, the light communication port 35b of the light transmission channel 40b, the coupling material 70b and the plurality of connectors 50b may be located between the lateral surface 13b of the photonic structure 10b and the second surface 22b of the alignment component 20b. The second surface 22b of the alignment component 20b is opposite to the first surface 21b of the alignment component 20b. The through hole 25b of the alignment component 20b extends between the first surface 21b and the second surface 22b. The light communication port 35b of the light transmission channel 40b may be aligned with the optical I/O 15b of the photonic structure 10b through the plurality of alignment pads 26b during the reflow process. The coupling material 70b may be disposed between the light communication port 35b of the light transmission channel 40b and the optical I/O 15b of the photonic structure 10b. The plurality of connectors 50 may connect the plurality of alignment pads 26b of the alignment component 20b to the plurality of bonding pads 16b exposed from the lateral surface 13b of the photonic structure 10b .

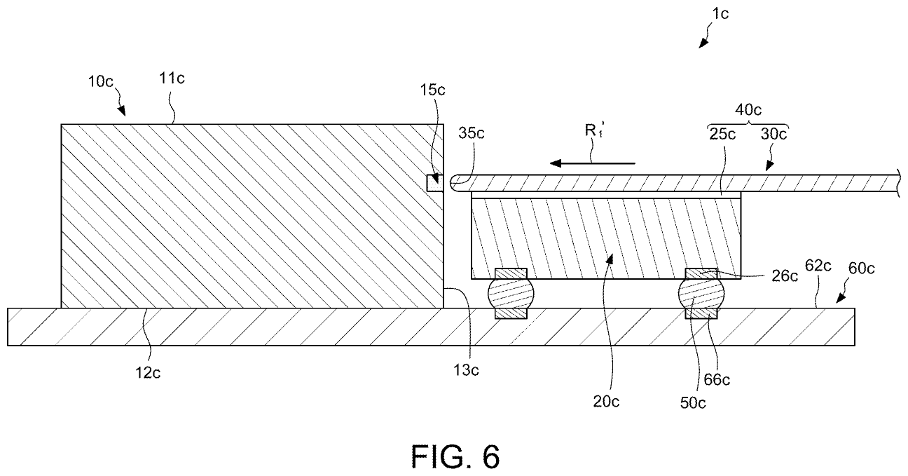

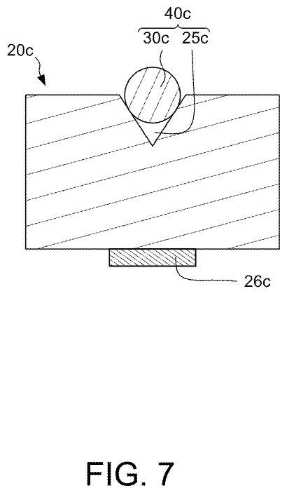

FIG. 6 illustrates a cross-sectional view of an optoelectronic package 1c according to some embodiments of the present disclosure. FIG. 7 illustrates a cross-sectional view of an alignment component 20c according to some embodiments of the present disclosure. The optoelectronic package 1c of FIG. 6 is similar to the optoelectronic package 1 of FIG. 1, except for configurations of the photonic structure 10c and the alignment component 20c and a structure of the carrier 60c. In some embodiments, as shown in FIG. 6, the optical I/O 15c of the photonic structure 10c may be exposed from the lateral surface 13c extending between the upper surface 11c and the lower surface 12c. In addition, the photonic structure 10c of FIG. 6 omits the plurality of bonding pads 16 of FIG. 1. The carrier 60c may further include a plurality of bonding pads 66c exposed from the first surface (e.g., the top surface) 62c of the carrier 60c. The alignment component 20c may be located over the carrier 60c. That is, the carrier 60c may be configured to receive the photonic structure 10c and the alignment component 20c. In some embodiments, the alignment component 20c (e.g., the plurality of alignment pads 26c) may be electrically connected to the carrier 60c (e.g., the first surface 62c) through the plurality of connectors 50c. In some embodiments, as shown in FIG. 6 and FIG. 7, the alignment component 20c may include a V-groove 25c aligned with the optical I/O 15c of the photonic structure 10c. The light transmission element 30c may be disposed in the V-groove 25c to constitute a light transmission channel 40c. The alignment component 20c may align the light transmission channel 40c with the optical I/O 15c of the photonic structure 10c in a first direction R₁′. The first direction R₁′ may be substantially parallel to the first surface (e.g., the top surface) 62c of the carrier 60c. In some embodiments, the light transmission channel 40c (including, for example, the V-groove 25c of the alignment component 20c and the light transmission element 30c in the V-groove 25c) may be aligned with the optical I/O 15c of the photonic structure 10c through the plurality of alignment pads 26c during the reflow process, lead to increased light coupling efficiency between a light communication port 35c of the light transmission channel 40c and the optical I/O 15c of the photonic structure 10c and decreased loss of the optical signal. In some embodiments, the light transmission channel 40c may include an extending direction that is substantially parallel to the first surface 62c of the carrier 60c. In some embodiments, the plurality of alignment pads 26c may be located on the alignment component 20c and between the light transmission channel 40c and the carrier 60c. In some embodiments, the arrangement of the plurality of alignment pads 26c of FIG. 6 may be the same as the arrangement of the plurality of alignment pads 26 of FIG. 3. The plurality of alignment pads 26c of FIG. 6 may be arranged in a second direction and a third direction that are same as the second direction R₂ and the third direction R₃ of FIG. 3, respectively. The extending direction of the light transmission channel 40c is not parallel to the second direction and the third direction. The plurality of connectors 50c may connect the plurality of alignment pads 26c of the alignment component 20c to the plurality of bonding pads 66c of the carrier 60c.

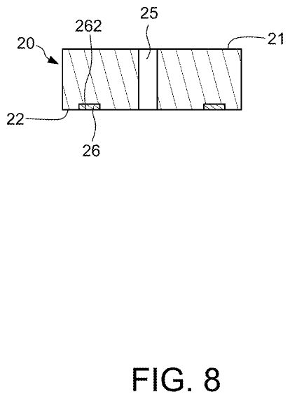

FIG. 8 through FIG. 10 illustrate a method for manufacturing an optoelectronic package according to some embodiments of the present disclosure. In some embodiments, the method is for manufacturing the optoelectronic package 1 shown in FIG. 1.

Referring to FIG. 8, an alignment component 20 is provided. The alignment component 20 of FIG. 8 may be the same as the alignment component 20 of FIG. 1. Thus, the alignment component 20 of FIG. 8 may include a through hole 25 and a plurality of alignment pads 26. The through hole 25 may extend through the alignment component 20 and in communication with an upper surface 21 and a lower surface 22 of the alignment component 20. The plurality of alignment pads 26 may be located on and exposed from the lower surface 22 of the alignment component 20.

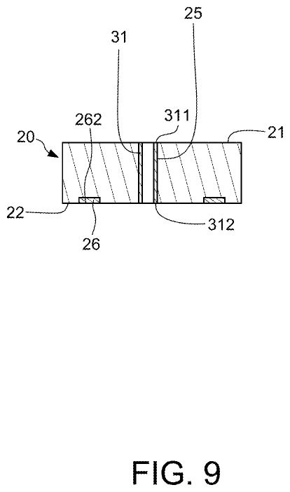

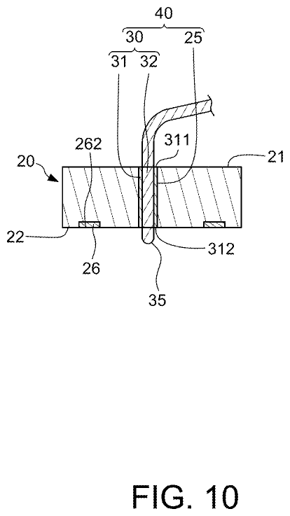

Referring to FIG. 9 through FIG. 10, a light transmission element 30 is formed to entirely fill the through hole 25 of the alignment component 20. Referring to FIG. 9, a filling material 31 is formed in the through hole 25 of the alignment component 20. The filling material 31 of FIG. 9 may be the same as the filling material 31 of FIG. 1. Referring to FIG. 10, an optical fiber 32 extends through the filling material 31 to form the light transmission element 30. The optical fiber 32 of FIG. 10 may be the same as the optical fiber 32 of FIG. 1. The light transmission element 30 and the through hole 25 of the alignment component 20 may constitute a light transmission channel 40. The light transmission channel 40 (including, for example, the light transmission element 30 and the through hole 25 of the alignment component 20) may include a light communication port 35 located outside the through hole 25 of the alignment component 20.

Referring to FIG. 1, the assembly of the light transmission channel 40 and the alignment component 20 is connected to the photonic structure 10 through a plurality of connectors 50. In some embodiments, the light communication port 35 of the light transmission channel 40 is aligned with an optical I/O 15 of a photonic structure 10 through the plurality of alignment pads 26 of the alignment component 20 during a reflow process. The photonic structure 10 is formed or disposed on a carrier 60.

After the reflow process, the alignment component 20 is bonded to the photonic structure 10 to obtain the optoelectronic package 1 of FIG. 1.

Spatial descriptions, such as “above,” “below,” “up,” “left,” “right,” “down,” “top,” “bottom,” “vertical,” “horizontal,” “side,” “higher,” “lower,” “upper,” “over,” “under,” and so forth, are indicated with respect to the orientation shown in the figures unless otherwise specified. It should be understood that the spatial descriptions used herein are for purposes of illustration only, and that practical implementations of the structures described herein can be spatially arranged in any orientation or manner, provided that the merits of embodiments of this disclosure are not deviated from by such an arrangement.

As used herein, the terms “approximately,” “substantially,” “substantial” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, a first numerical value can be deemed to be “substantially” the same or equal to a second numerical value if the first numerical value is within a range of variation of less than or equal to ±10% of the second numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Two surfaces can be deemed to be coplanar or substantially coplanar if a displacement between the two surfaces is no greater than 5 μm, no greater than 2 μm, no greater than 1 μm, or no greater than 0.5 μm. A surface can be deemed to be substantially flat if a displacement between a highest point and a lowest point of the surface is no greater than 5 μm, no greater than 2 μm, no greater than 1 μm, or no greater than 0.5 μm.

As used herein, the singular terms “a,” “an,” and “the” may include plural referents unless the context clearly dictates otherwise.

As used herein, the terms “conductive,” “electrically conductive” and “electrical conductivity” refer to an ability to transport an electric current. Electrically conductive materials typically indicate those materials that exhibit little or no opposition to the flow of an electric current. One measure of electrical conductivity is Siemens per meter (S/m). Typically, an electrically conductive material is one having a conductivity greater than approximately 10⁴ S/m, such as at least 10⁵ S/m or at least 10⁶ S/m. The electrical conductivity of a material can sometimes vary with temperature. Unless otherwise specified, the electrical conductivity of a material is measured at room temperature.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified.

While the present disclosure has been described and illustrated with reference to specific embodiments thereof, these descriptions and illustrations are not limiting. It should be understood by those skilled in the art that various changes may be made and equivalents may be substituted without departing from the true spirit and scope of the present disclosure as defined by the appended claims. The illustrations may not be necessarily drawn to scale. There may be distinctions between the artistic renditions in the present disclosure and the actual apparatus due to manufacturing processes and tolerances. There may be other embodiments of the present disclosure which are not specifically illustrated. The specification and drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations of the present disclosure.

What is claimed is:

1. An optoelectronic package, comprising:
a photonic structure including an optical I/O;
an alignment component including a through hole extending through the alignment component and aligned with the optical I/O of the photonic structure; and
a light transmission element entirely filling the through hole of the alignment component.

2. The optoelectronic package of claim 1, wherein the light transmission element includes a light communication port located outside the through hole of the alignment component.

3. The optoelectronic package of claim 2, wherein the light communication port is an optical surface from which light leaves or enters the light transmission element.

4. The optoelectronic package of claim 2, further comprising a lens structure on the light communication port.

5. The optoelectronic package of claim 2, further comprising a plurality of connectors around the light communication port, wherein an elevation of the light communication port is between elevations of top surfaces of the plurality of connectors and elevations of bottom surfaces of the plurality of connectors.

6. The optoelectronic package of claim 2, further comprising a coupling material isolating a portion of the light communication port from the air.

7. The optoelectronic package of claim 6, wherein the coupling material adheres the light communication port and the optical I/O.

8. The optoelectronic package of claim 1, wherein the light transmission element includes a filling material in the through hole and an optical fiber extending through the filling material.

9. The optoelectronic package of claim 8, wherein a refractive index of the filling material is less than a refractive index of the optical fiber.

10. The optoelectronic package of claim 1, wherein the light transmission element includes an optical through silicon via (TSV) in the through hole and an optical fiber coupled to a top surface of the optical TSV.

11. The optoelectronic package of claim 10, further comprising an index matching material between the optical fiber and the top surface of the optical TSV.

12. An optoelectronic package, comprising:
a photonic structure including an optical receive region; and
a component fixing a light transmission channel and aligning the light transmission channel with the optical receive region of the photonic structure through a plurality of alignment pads on the component.

13. The optoelectronic package of claim 12, further comprising a reflowable element connecting the plurality of alignment pads to the photonic structure.

14. The optoelectronic package of claim 12, wherein the photonic structure is disposed on a first surface of a carrier, and the plurality of alignment pads are connected to a second surface of the photonic structure.

15. The optoelectronic package of claim 14, wherein the first surface of the carrier is substantially perpendicular to the second surface of the photonic structure.

16. The optoelectronic package of claim 12, wherein the photonic structure is disposed on a first surface of a carrier, and the plurality of alignment pads are connected to the first surface of the carrier.

17. The optoelectronic package of claim 16, wherein the light transmission channel further comprises an extending direction that is substantially parallel to the first surface of the carrier.

18. An optoelectronic package, comprising:
a photonic structure including an optical I/O; and
a component aligning a light transmission channel with the optical I/O of the photonic structure in a first direction; wherein the component comprises a plurality of alignment pads arranged in a second direction different from the first direction.

19. The optoelectronic package of claim 18, wherein the first direction is substantially perpendicular to the second direction.

20. The optoelectronic package of claim 19, wherein the plurality of alignment pads are further arranged in a third direction different from the first direction and the second direction.
